(19) United States
(12) Patent Application Publication
(10) Pub. No.: US 2026/0197851 A1
(43) Pub. Date: Jul. 9, 2026

(54) COMMAND-BASED OPERATION FOR READERS

(71) Applicant: QUALCOMM Incorporated, San Diego, CA (US)

(72) Inventors: Ahmed Abdelaziz Ibrahim Abdelaziz ZEWAIL, San Diego, CA (US); Chengjin ZHANG, San Diego, CA (US); Zhifei FAN, San Diego, CA (US)

(21) Appl. No.: 19/014,890

(22) Filed: Jan. 9, 2025

(51) Int. Cl. H04W 72/51; G16Y 40/35

(52) U.S. Cl. CPC H04W 72/51; G16Y 40/35

(57) ABSTRACT

In some aspects, a network entity may transmit an indication of an allocation of one or more time query resources or frequency query resources to one or more first readers of the plurality of readers. The network entity may transmit an indication of an allocation of one or more time random number (RN) carrier wave (CW) resources or frequency RN CW resources to one or more second readers of the plurality of readers. The network entity may transmit an indication of an allocation of one or more time acknowledgment (ACK) resources or frequency ACK resources to one or more third readers of the plurality of readers. The network entity may transmit an indication of an allocation of one or more time identifier CW resources or frequency identifier CW resources to one or more fourth readers of the plurality of readers. Numerous other aspects are described.

### FIELD OF THE DISCLOSURE

Aspects of the present disclosure generally relate to wired or wireless communication and, for example, to command-based operation for readers.

### BACKGROUND

Some internet of things (IoT) devices, such as ambient IoT devices, may be associated with a relatively simple hardware design that may be designed to use low power and be implementable at low cost. Ambient IoT technology may be useful in connection with industrial sensors, for which battery replacement may be prohibitively difficult or undesirable (such as for safety monitoring or fault detection in smart factories, infrastructures, or environments). Additionally, features of ambient IoT devices, such as low cost, small size, simple or infrequent maintenance, durability, and long lifespan, may facilitate smart logistics and warehousing (for example, in connection with automated asset management). Furthermore, ambient IoT technology may be useful in connection with smart home networks for household item management, wearable devices, or similar applications.

### SUMMARY

Some aspects described herein relate to an apparatus for network communication at a network entity. The apparatus may include one or more memories and one or more processors coupled to the one or more memories. The one or more processors may be configured to cause the network entity to transmit a command-based operation configuration for a plurality of readers. The one or more processors may be configured to cause the network entity to transmit an indication of an allocation of one or more time query resources or frequency query resources to one or more first readers of the plurality of readers. The one or more processors may be configured to cause the network entity to transmit an indication of an allocation of one or more time random number (RN) carrier wave (CW) resources or frequency RN CW resources to one or more second readers of the plurality of readers. The one or more processors may be configured to cause the network entity to transmit an indication of an allocation of one or more time acknowledgment (ACK) resources or frequency ACK resources to one or more third readers of the plurality of readers. The one or more processors may be configured to cause the network entity to transmit an indication of an allocation of one or more time identifier CW resources or frequency identifier CW resources to one or more fourth readers of the plurality of readers.

Some aspects described herein relate to a method of network communication performed by a network entity. The method may include transmitting a command-based operation configuration for a plurality of readers. The method may include transmitting an indication of an allocation of one or more time query resources or frequency query resources to one or more first readers of the plurality of readers. The method may include transmitting an indication of an allocation of one or more time RN CW resources or frequency RN CW resources to one or more second readers of the plurality of readers. The method may include transmitting an indication of an allocation of one or more time ACK resources or frequency ACK resources to one or more third readers of the plurality of readers. The method may include transmitting an indication of an allocation of one or more time identifier CW resources or frequency identifier CW resources to one or more fourth readers of the plurality of readers.

Some aspects described herein relate to an apparatus for wireless communication. The apparatus may include means for transmitting a command-based operation configuration for a plurality of readers. The apparatus may include means for transmitting an indication of an allocation of one or more time query resources or frequency query resources to one or more first readers of the plurality of readers. The apparatus may include means for transmitting an indication of an allocation of one or more time RN CW resources or frequency RN CW resources to one or more second readers of the plurality of readers. The apparatus may include means for transmitting an indication of an allocation of one or more time ACK resources or frequency ACK resources to one or more third readers of the plurality of readers. The apparatus may include means for transmitting an indication of an allocation of one or more time identifier CW resources or frequency identifier CW resources to one or more fourth readers of the plurality of readers.

Some aspects described herein relate to a non-transitory computer-readable medium that stores a set of instructions for wireless communication by a network entity. The set of instructions, when executed by one or more processors of the network entity, may cause the network entity to transmit a command-based operation configuration for a plurality of readers. The set of instructions, when executed by one or more processors of the network entity, may cause the network entity to transmit an indication of an allocation of one or more time query resources or frequency query resources to one or more first readers of the plurality of readers. The set of instructions, when executed by one or more processors of the network entity, may cause the network entity to transmit an indication of an allocation of one or more time RN CW resources or frequency RN CW resources to one or more second readers of the plurality of readers. The set of instructions, when executed by one or more processors of the network entity, may cause the network entity to transmit an indication of an allocation of one or more time ACK resources or frequency ACK resources to one or more third readers of the plurality of readers. The set of instructions, when executed by one or more processors of the network entity, may cause the network entity to transmit an indication of an allocation of one or more time identifier CW resources or frequency identifier CW resources to one or more fourth readers of the plurality of readers.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIG. 3 is a diagram illustrating an example associated with signaling for command-based operation for readers, in accordance with the present disclosure.

FIG. 4 is a flowchart of an example process associated with command-based operation for readers, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Internet of things (IoT) devices may be passive, semi-passive, or active. A passive IoT device, such as a terminal (e.g., a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from a radio frequency source to convey data. At a semi-passive IoT device, communication between a reader and the IoT device does not need to be preceded by an energy harvesting waveform. For example, a semi-passive IoT device may include a battery or similar energy source that can power the semi-passive IoT device. An active IoT device may have a battery or similar energy source and an active radio, allowing for active transmission and reception without energy harvesting or backscattering.

A reader may be a user equipment (UE), a network node, or any other suitable device capable of wireless communication with an ambient IoT device. In some examples, a reader may transmit, and an ambient IoT device may receive, data over a reader-to-device (R2D) link, an energizing signal, and/or a carrier wave (CW). Additionally, or alternatively, an ambient IoT device may transmit, and a reader may receive, data over a device-to-reader (D2R) link. For example, the ambient IoT device may transmit data over the D2R link by harvesting energy from the energizing signal and/or backscattering the CW.

Ambient IoT devices and readers may be arranged in an ambient IoT topology, such as a first topology referred to as Topology 1 or a second topology referred to as Topology 2. In Topology 1, an ambient IoT device may directly and bidirectionally communicate with one or more network nodes (e.g., one or more readers). Topology 1 may provide continuous coverage in indoor settings, and may be deployed in enterprise environments (e.g., warehouses, factories, retail stores, or the like). In Topology 2, an ambient IoT device may communicate bidirectionally with an intermediate node (e.g., a reader) between the ambient IoT device and a network node. The intermediate node (e.g., a relay, an integrated access and backhaul (IAB) node, a UE, a repeater, or the like) may transfer communications between the network node and the ambient IoT device. Topology 2 may enable handheld scanning using a smartphone, and may be deployed in enterprise environments or consumer homes. Topology 1 or Topology 2 may support inventory use cases (where ambient IoT devices are used to take an inventory), sensing use cases (where ambient IoT devices function as sensors), or command use cases (where ambient IoT devices perform operations in accordance with commands).

Traditionally, a radio frequency identification (RFID) reader may be deployed at a chokepoint or gate of an indoor setting (e.g., a warehouse). By contrast, multiple ambient IoT readers may be deployed to provide continuous coverage throughout the indoor setting. The multiple ambient IoT readers may enable faster inventory, improved product tracking, or the like. A central controller may manage the multiple ambient IoT readers, collect reading data, or the like. The central controller may be referred to as a network commander, a central control unit, or the like. An ambient IoT reader may operate in a given mode depending on scheduling decisions made by the central controller.

The central controller that schedules and coordinates multiple readers (e.g., low-cost ambient IoT readers) in an ambient IoT topology (e.g., Topology 1) could improve coverage of ambient IoT devices (e.g., low-cost ambient IoT devices) within that ambient IoT topology. For example, a coverage range of each reader (e.g., an inter-cell site distance (ISD) of each reader) may be 20-30 meters in non-line-of-sight (NLOS) scenarios. A licensed band (e.g., below 1 GHz) may enable higher reader transmit power (e.g., effective isotropic radio power), such as 36-42 decibel-milliwatts (dBm). Furthermore, the central controller may enable a multi-point energizing combining gain, and a sensitivity of an ambient IoT device may be 6-8 dB better than an RFID tag. Additionally, or alternatively, the central controller may enable bistatic transmission, which may reduce self-interference due to a CW and thereby improve reader receive sensitivity by at least 15 dB. Moreover, the ambient IoT topology may provide a channel coding gain of 4 dB compared to RFID. For example, the central controller may control at least four readers (R1, R2, R3, and R4). The central controller may cause each of the readers to transmit energizing signals to an ambient IoT device, R2 to transmit an R2D command, R4 to transmit a CW, and R2 to receive a D2R response. However, such coordination using the central controller may be hindered by listen-before-talk (LBT) techniques, which are used in RFID technology.

In RFID, a frequency band of 865-868 MHz is allocated for RFID deployment. This frequency band is divided into 15 sub-bands or channels, each spanning a total of 200 kHz. However, when an RFID interrogator (e.g., an RFID reader) is operating at a maximum radiated power (e.g., 2 watts of effective radiated power), only 10 sub-bands are available because the remaining 5 sub-bands are utilized as guard bands. The RFID interrogator may employ LBT as follows. Before transmitting an RFID communication, the RFID interrogator attempts to detect the presence of other signals by “listening” (e.g., monitoring) within a target sub-band for the RFID communication. The listen time (e.g., the length of time during which the RFID interrogator listens for other signals) may include a fixed period of 5 milliseconds plus a random time equal to one of 11 steps between 0 ms to 5 ms. If the sub-band is free (e.g., if no other signals are detected), then the random time may be set to 0 ms. After selecting a sub-band, the RFID interrogator may use that sub-band (e.g., “talk”) for up to 4 seconds. After using the sub-band, the RFID interrogator may free (e.g., refrain from transmitting on) the sub-band for at least 100 ms. However, the RFID interrogator may listen to another sub-band for 5 ms and, if the other sub-band is free, use the other sub-band.

Communications in RFID systems may follow a four-step procedure. In a first step, an RFID interrogator may transmit a query. In a second step, an RFID tag may respond with a random 16-bit number. In a third step, the RFID interrogator may transmit an acknowledgment (ACK) with the random 16-bit number. In a fourth step, the RFID tag may respond with an electronic product code of the RFID tag. In multi-RFID-interrogator deployments, an RFID interrogator may apply an LBT-based scheme before accessing an RFID medium (e.g., before transmitting a query). LBT may minimize interference between RFID interrogators because the RFID interrogators may avoid transmitting and/or receiving in the same time and frequency resources.

However, applying LBT to ambient IoT scenarios may mitigate coverage improvements that would otherwise be afforded by a central controller capable of coordinating multiple readers. For example, readers using LBT operate in a standalone mode, which limits coverage provided by the readers. For example, LBT may prevent multiple readers from transmitting simultaneous energizing signals, performing different parts of the same inventory procedure, or the like. Thus, LBT in the ambient IoT context may reduce energizing gains, increase self-interference, or the like.

Some implementations described herein enable a central controller to synchronize, exchange data, and/or allocate resources to a plurality of ambient IoT readers. For example, the central controller may manage inventory operations of the ambient IoT readers. In some aspects, the central controller may transmit time and/or frequency resource information that the ambient IoT readers can use to transmit queries to ambient IoT devices. In some aspects, the central controller may transmit time and/or frequency resource information that the ambient IoT readers can use to transmit CWs to the ambient IoT devices, and the ambient IoT devices may backscatter random numbers (RNs) using the CW. In some aspects, the central controller may transmit time and/or frequency resource information that the ambient IoT readers can use to transmit ACKs to the ambient IoT devices. In some aspects, the central controller may transmit time and/or frequency resource information that the ambient IoT readers can use to transmit additional CWs to the ambient IoT devices, and the ambient IoT devices may backscatter ambient IoT device identifiers using the additional CWs.

As a result, the central controller may coordinate the ambient IoT readers and thereby enhance overall coverage. For example, instead of using LBT, the ambient IoT readers may perform coordinated inventory operations, such as simultaneously transmitting energizing signals, performing different phases of the same inventory procedure, or the like. Thus, the central controller may help to increase energizing gains, increase self-interference, or the like.

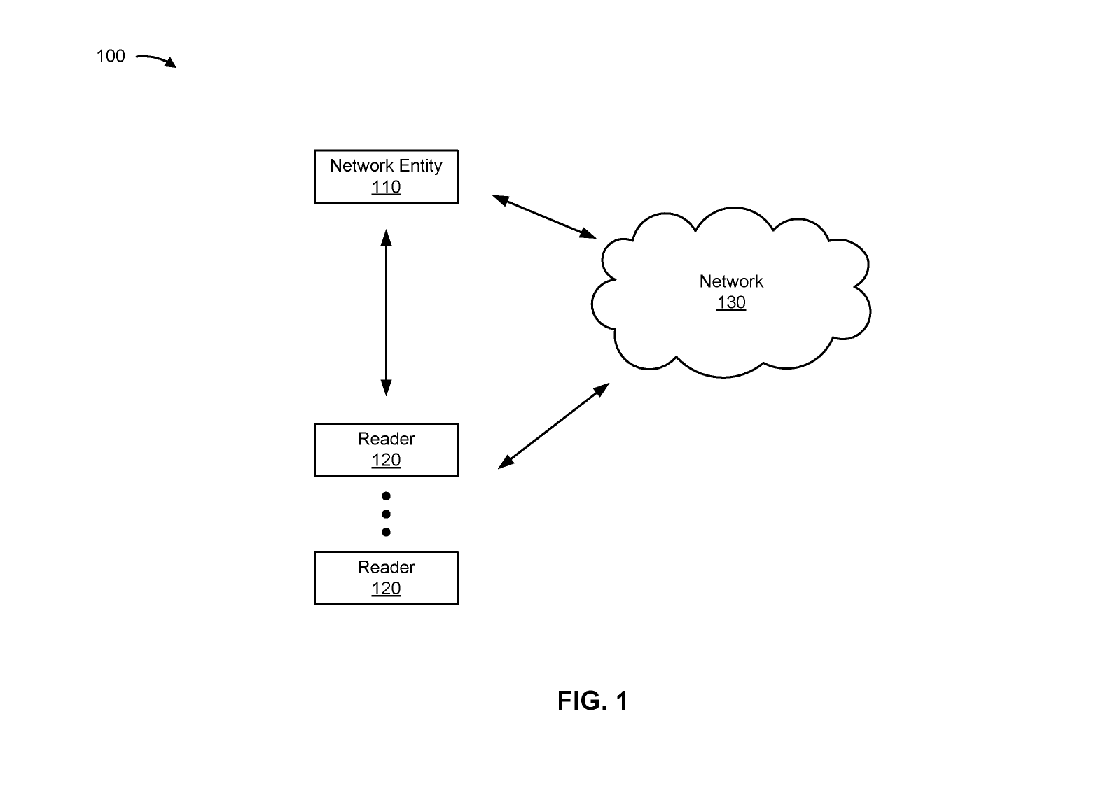

FIG. 1 is a diagram of an example environment 100 in which systems and/or methods described herein may be implemented. As shown in FIG. 1, environment 100 may include a network entity 110, a plurality of readers 120, and a network 130. Devices of environment 100 may interconnect via wired connections, wireless connections, or a combination of wired and wireless connections.

The network entity 110 may include one or more devices capable of receiving, generating, storing, processing, and/or providing information associated with command-based operation for readers, as described elsewhere herein. For example, the network entity 110 may include a communication device, a computing device, and/or a server. For example, the network entity 110 may be the central controller.

A reader 120 includes one or more devices capable of receiving, generating, storing, processing, and/or providing information associated with command-based operation for readers, as described elsewhere herein. For example, the reader 120 may include a network node, a relay, an IAB node, a UE, a repeater, and/or the like.

The network 130 may include one or more wired and/or wireless networks. For example, the network 130 may include a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

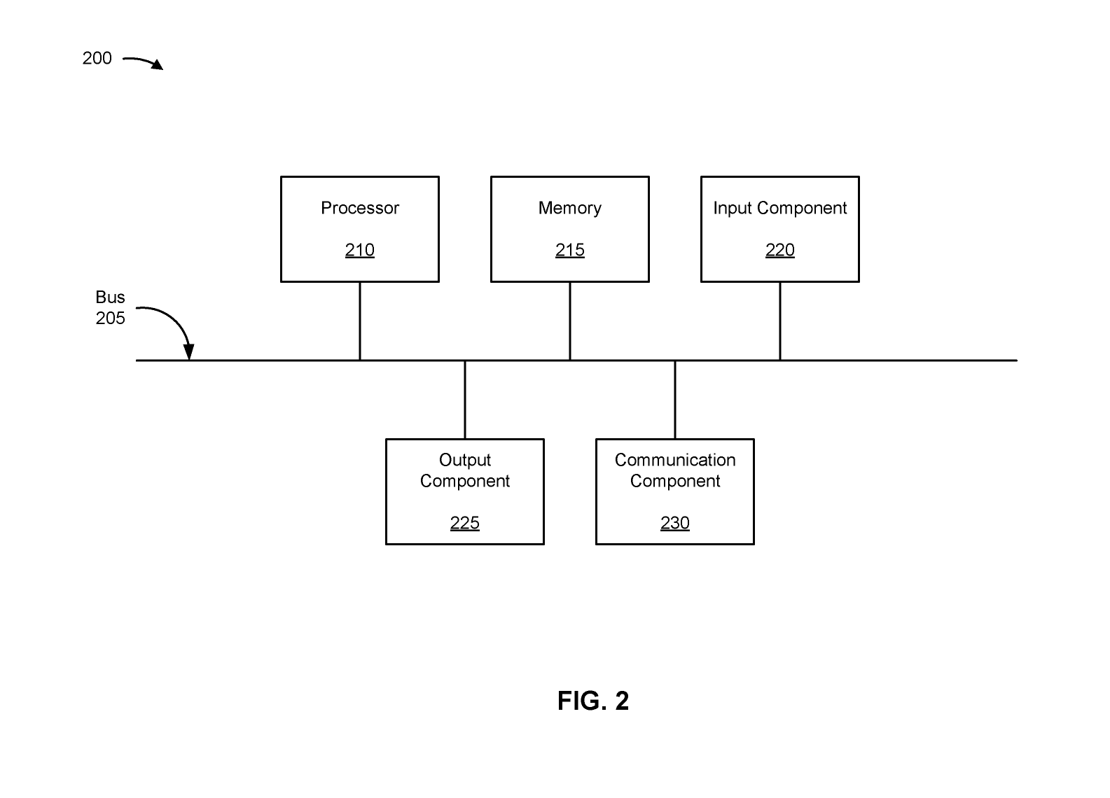

FIG. 2 is a diagram illustrating example components of a device 200, in accordance with the present disclosure. The device 200 may correspond to the network entity 110 and/or a reader 120. In some aspects, the network entity 110 and/or a reader 120 may include one or more devices 200 and/or one or more components of the device 200. As shown in FIG. 2, the device 200 may include a bus 205, a processor 210, a memory 215, an input component 220, an output component 225, and/or a communication component 230.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for transmitting a command-based operation configuration for a plurality of readers; means for transmitting an indication of an allocation of one or more time query resources or frequency query resources to one or more first readers of the plurality of readers; means for transmitting an indication of an allocation of one or more time RN CW resources or frequency RN CW resources to one or more second readers of the plurality of readers; means for transmitting an indication of an allocation of one or more time ACK resources or frequency ACK resources to one or more third readers of the plurality of readers; and/or means for transmitting an indication of an allocation of one or more time identifier CW resources or frequency identifier CW resources to one or more fourth readers of the plurality of readers. In some aspects, the means for device 200 to perform processes and/or operations described herein may include one or more components of device 200 described in connection with FIG. 2, such as bus 205, processor 210, memory 215, input component 220, output component 225, and/or communication component 230.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

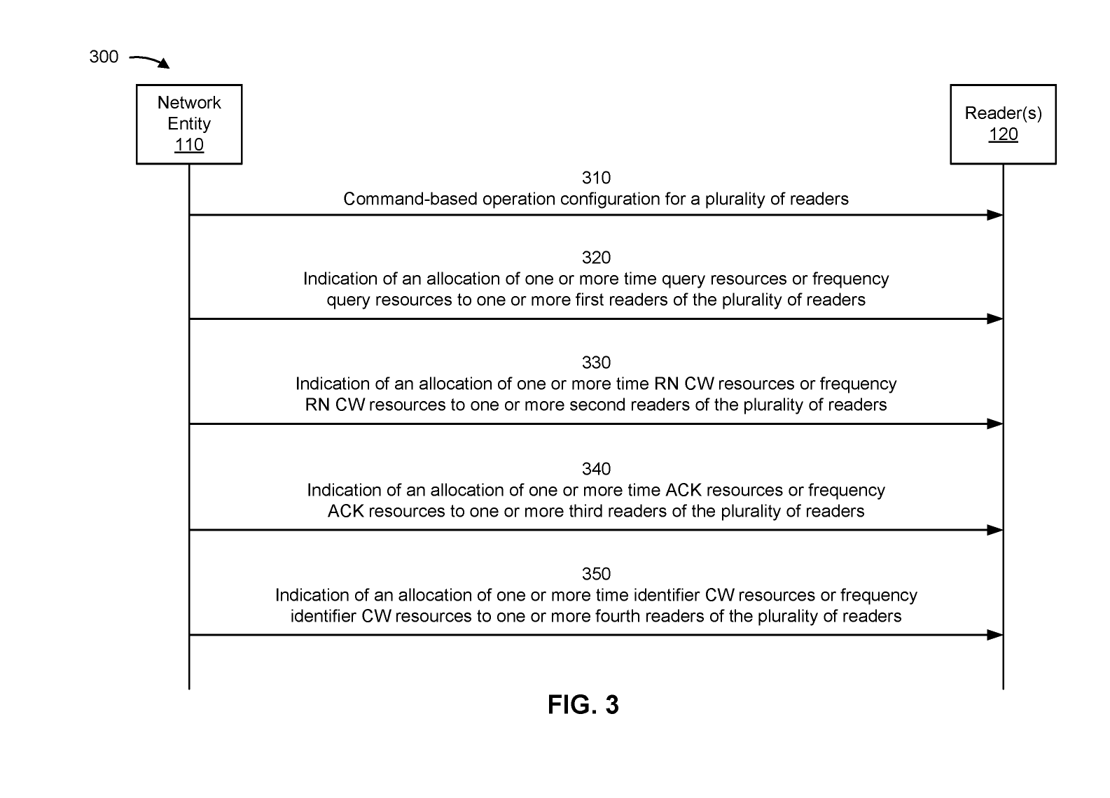

FIG. 3 is a diagram illustrating an example 300 associated with signaling for command-based operation for readers, in accordance with the present disclosure. As shown in FIG. 3, a network entity 110 and one or more readers 120 may communicate with one another. For example, the network entity 110 and the reader(s) 120 may be connected via one or more wireless or wired backhaul links (e.g., Ethernet links). In some examples, communications described in connection with FIG. 3 between the network entity 110 and the reader(s) 120 may be carried via the backhaul link(s).

As shown by reference number 310, the network entity 110 may transmit a command-based operation configuration for the plurality of readers 120. The command-based operation configuration may configure the plurality of readers 120 to operate based at least in part on commands received from the network entity 110. For example, the commands may enable the network entity 110 to synchronize the reader(s) 120, exchange data with the reader(s) 120, allocate resources to the reader(s) 120, or the like. In some examples, the network entity 110 may transmit either the command-based operation configuration or an LBT-based configuration that configures the plurality of readers 120 to operate based at least in part on LBT, which may hinder coordination between the plurality of readers.

In some aspects, the command-based operation configuration may be associated with ambient IoT inventory. In ambient IoT inventory, one or more of the readers 120 may collect inventory data from ambient IoT devices. The command-based operation configuration may be associated with ambient IoT inventory in that the command-based operation configuration may apply to ambient IoT inventory (e.g., the commands may be ambient IoT inventory commands). For example, the command-based operation configuration may be limited to ambient IoT inventory such that the readers 120 operate based at least in part on the commands for ambient IoT inventory operations, and/or the readers 120 may operate based at least in part on LBT for other operations.

As shown by reference number 320, the network entity 110 may transmit an indication of an allocation of one or more time query resources or frequency query resources to one or more first readers of the plurality of readers 120. The one or more time query resources or frequency query resources may be time or frequency resources in which the one or more first readers are to transmit one or more queries. For example, the indication of the allocation may include timing information for a query and/or one or more frequency domain resources for the query. In some examples, the indication may help to establish a first phase of communication between the reader(s) 120 and ambient IoT devices in which the one or more first readers are synchronized and transmit one or more queries to one or more ambient IoT devices.

In some aspects, the one or more time query resources or frequency query resources may include the one or more time query resources. For example, the network entity 110 may transmit an indication of an allocation of one or more time query resources to the one or more first readers. In some examples, the one or more time query resources may synchronize, in the time domain, one or more queries transmitted by the one or more first readers.

In some aspects, the one or more time query resources or frequency query resources may include one or more channels allocated to respective readers of the one or more first readers. For example, the network entity 110 may transmit an indication of an allocation of the one or more channels. In some examples, the one or more channels may synchronize, in the frequency domain, one or more queries transmitted by the one or more first readers.

In some aspects, the network entity 110 may transmit an indication of query content information associated with the one or more time query resources or frequency query resources. The query content information may be associated with the one or more time query resources or frequency query resources in that the query content information may indicate content of one or more queries that are to be transmitted in the one or more time query resources or frequency query resources. For example, the query content information may indicate one or more properties of the ambient IoT devices that are to provide inventory data.

As shown by reference number 330, the network entity 110 may transmit an indication of an allocation of one or more time random number (RN) carrier wave (CW) resources or frequency RN CW resources to one or more second readers of the plurality of readers 120. The one or more time RN CW resources or frequency RN CW resources may be time or frequency resources in which the one or more second readers are to transmit one or more RN CWs. An RN CW is a CW that is to be backscattered by an ambient IoT device to transmit an RN that is generated in accordance with the query. In some examples, the second readers may be assigned different time and frequency resources in which to transmit the RN CWs. In some examples, the indication may help to establish a second phase of communication between the reader(s) 120 and ambient IoT devices in which one or more of the reader(s) 120 transmit RN CW(s) and/or scan for one or more responses (e.g., monitor for backscattered RN(s)).

In some aspects, the network entity 110 may transmit an indication of an assignment of the one or more second readers to CW transmission and one or more third readers of the plurality of readers 120 to RN monitoring. Thus, the network entity 110 may assign different roles to various groups of the readers 120. For example, the network entity 110 may indicate that the one or more second readers are to transmit the RN CW(s) in the one or more time RN CW resources or frequency RN CW resources, and that the one or more third readers are to scan for the one or more responses.

As shown by reference number 340, the network entity 110 may transmit an indication of an allocation of one or more time ACK resources or frequency ACK resources to one or more fourth readers of the plurality of readers 120. The one or more time ACK resources or frequency ACK resources may be time or frequency resources in which the one or more fourth readers (e.g., a single reader or multiple synchronized readers) are to transmit one or more ACKs (e.g., one or more ACK messages). The ACKs may indicate that an RN of an ambient IoT device has been received. In some examples, the network entity 110 may determine the allocation by assigning one or more ambient IoT devices, the one or more time ACK resources, and/or the one or more frequency ACK resources to the one or more fourth readers based at least in part on the one or more responses (e.g., the one or more RNs). In some examples, the indication may help to establish a third phase of communication between the reader(s) 120 and ambient IoT devices in which one or more of the reader(s) 120 transmit ACK(s) to one or more of the ambient IoT devices.

As shown by reference number 350, the network entity 110 may transmit an indication of an allocation of one or more time identifier CW resources or frequency identifier CW resources to one or more fifth readers of the plurality of readers 120. The one or more time identifier CW resources or frequency identifier CW resources may be time or frequency resources in which the one or more fifth readers are to transmit one or more identifier CWs. An identifier CW is a CW that is to be backscattered by an ambient IoT device to transmit an identifier of the ambient IoT device in accordance with an ACK. In some examples, the fifth readers may be assigned different time and frequency resources in which to transmit the identifier CWs. In some examples, the indication may help to establish a fourth phase of communication between the reader(s) 120 and ambient IoT devices in which one or more of the reader(s) 120 transmit identifier CW(s) and/or scan for one or more responses (e.g., monitor for backscattered identifier(s)).

In some aspects, the network entity 110 may transmit an indication of an assignment of the one or more fifth readers to CW transmission and one or more sixth readers of the plurality of readers 120 to identifier monitoring. Thus, the network entity 110 may assign different roles to various groups of the readers 120. For example, the network entity 110 may indicate that the one or more fifth readers are to transmit the identifier CW(s) in the one or more time identifier CW resources or frequency identifier CW resources, and that the one or more sixth readers are to scan for the one or more responses.

In some examples, the various communications described in connection with FIG. 3 between the network entity 110 and the reader(s) 120 may be transmitted together (e.g., simultaneously or in a single message) or separately (e.g., sequentially or across multiple messages). As one example, the command-based operation configuration may contain the indication of the allocation of the one or more time query resources or frequency query resources to the one or more first readers. Additionally, or alternatively, with reference to a first set of readers (e.g., one of the one or more first readers, the one or more second readers, the one or more third readers, the one or more fourth readers, the one or more fifth readers, or the one or more sixth readers) and a second set of readers (e.g., another one of the one or more first readers, the one or more second readers, the one or more third readers, the one or more fourth readers, the one or more fifth readers, or the one or more sixth readers), the first set of readers may include all, some, or none of the readers that are included in the second set of readers.

The command-based operation configuration and the indications described above in connection with reference numbers 320-350 may enable the network entity 110 to coordinate the readers 120 and thereby enhance overall coverage. For example, instead of using LBT, the readers 120 may perform coordinated inventory operations, such as simultaneously transmitting energizing signals, performing different phases of the same inventory procedure, or the like. Thus, the network entity 110 may help to increase energizing gains, increase self-interference, or the like.

The one or more time query resources or frequency query resources including the one or more time query resources (e.g., transmitting an indication of an allocation of the one or more time query resources) may enable the network entity 110 to allocate the time query resources so as to reduce interference caused by, or impacting, the one or more queries.

The one or more time query resources or frequency query resources including one or more channels allocated to respective readers of the one or more first readers may enable the network entity 110 to allocate different channels on which to transmit the one or more queries so as to reduce interference caused by, or impacting, the one or more queries.

As indicated above, FIG. 3 is provided as an example. Other examples may differ from what is described with respect to FIG. 3.

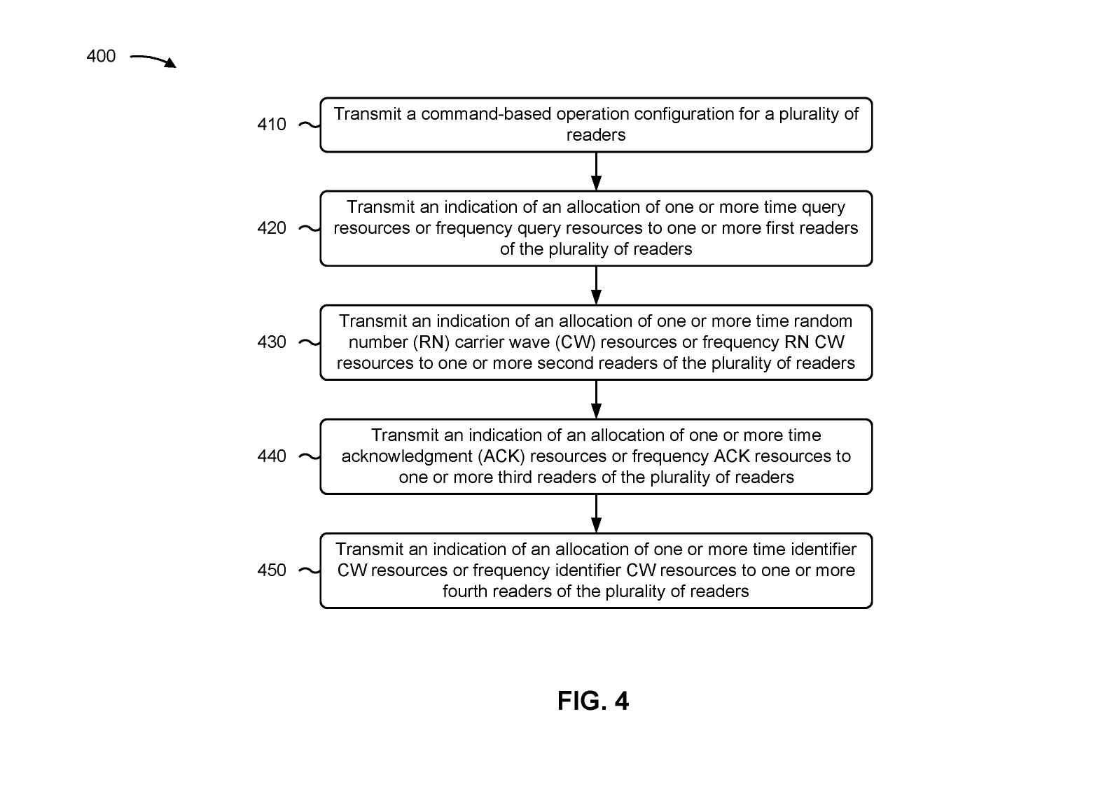

FIG. 4 is a flowchart of an example process 400 associated with command-based operation for readers, in accordance with the present disclosure. In some aspects, one or more process blocks of FIG. 4 are performed by a network entity (e.g., network entity 110). In some aspects, one or more process blocks of FIG. 4 are performed by another device or a group of devices separate from or including the network entity, such as one or more readers (e.g., one or more readers 120). Additionally, or alternatively, one or more process blocks of FIG. 4 may be performed by one or more components of device 200, such as processor 210, memory 215, input component 220, output component 225, and/or communication component 230.

As shown in FIG. 4, process 400 may include transmitting a command-based operation configuration for a plurality of readers (block 410). For example, the network entity may transmit a command-based operation configuration for a plurality of readers, as described above.

As further shown in FIG. 4, process 400 may include transmitting an indication of an allocation of one or more time query resources or frequency query resources to one or more first readers of the plurality of readers (block 420). For example, the network entity may transmit an indication of an allocation of one or more time query resources or frequency query resources to one or more first readers of the plurality of readers, as described above.

As further shown in FIG. 4, process 400 may include transmitting an indication of an allocation of one or more time RN CW resources or frequency RN CW resources to one or more second readers of the plurality of readers (block 430). For example, the network entity may transmit an indication of an allocation of one or more time RN CW resources or frequency RN CW resources to one or more second readers of the plurality of readers, as described above.

As further shown in FIG. 4, process 400 may include transmitting an indication of an allocation of one or more time ACK resources or frequency ACK resources to one or more third readers of the plurality of readers (block 440). For example, the network entity may transmit an indication of an allocation of one or more time ACK resources or frequency ACK resources to one or more third readers of the plurality of readers, as described above.

As further shown in FIG. 4, process 400 may include transmitting an indication of an allocation of one or more time identifier CW resources or frequency identifier CW resources to one or more fourth readers of the plurality of readers (block 450). For example, the network entity may transmit an indication of an allocation of one or more time identifier CW resources or frequency identifier CW resources to one or more fourth readers of the plurality of readers, as described above.

Process 400 may include additional aspects, such as any single aspect or any combination of aspects described below and/or in connection with one or more other processes described elsewhere herein.

In a first aspect, the command-based operation configuration is associated with ambient IoT inventory.

In a second aspect, alone or in combination with the first aspect, the one or more time query resources or frequency query resources include the one or more time query resources.

In a third aspect, alone or in combination with one or more of the first and second aspects, the one or more time query resources or frequency query resources include one or more channels allocated to respective readers of the one or more first readers.

In a fourth aspect, alone or in combination with one or more of the first through third aspects, process 400 includes transmitting an indication of query content information associated with the one or more time query resources or frequency query resources.

In a fifth aspect, alone or in combination with one or more of the first through fourth aspects, process 400 includes transmitting an indication of an assignment of the one or more second readers to CW transmission and one or more fifth readers of the plurality of readers to RN monitoring.

In a sixth aspect, alone or in combination with one or more of the first through fifth aspects, process 400 includes transmitting an indication of an assignment of the one or more second readers to CW transmission and one or more fifth readers of the plurality of readers to identifier monitoring.

Although FIG. 4 shows example blocks of process 400, in some aspects, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A method of network communication performed by a network entity, comprising: transmitting a command-based operation configuration for a plurality of readers; transmitting an indication of an allocation of one or more time query resources or frequency query resources to one or more first readers of the plurality of readers; transmitting an indication of an allocation of one or more time random number (RN) carrier wave (CW) resources or frequency RN CW resources to one or more second readers of the plurality of readers; transmitting an indication of an allocation of one or more time acknowledgment (ACK) resources or frequency ACK resources to one or more third readers of the plurality of readers; and transmitting an indication of an allocation of one or more time identifier CW resources or frequency identifier CW resources to one or more fourth readers of the plurality of readers.

Aspect 2: The method of Aspect 1, wherein the command-based operation configuration is associated with ambient internet of things (IoT) inventory.

Aspect 3: The method of any of Aspects 1-2, wherein the one or more time query resources or frequency query resources include the one or more time query resources.

Aspect 4: The method of any of Aspects 1-3, wherein the one or more time query resources or frequency query resources include one or more channels allocated to respective readers of the one or more first readers.

Aspect 5: The method of any of Aspects 1-4, further comprising: transmitting an indication of query content information associated with the one or more time query resources or frequency query resources.

Aspect 6: The method of any of Aspects 1-5, further comprising: transmitting an indication of an assignment of the one or more second readers to CW transmission and one or more fifth readers of the plurality of readers to RN monitoring.

Aspect 7: The method of any of Aspects 1-6, further comprising: transmitting an indication of an assignment of the one or more second readers to CW transmission and one or more fifth readers of the plurality of readers to identifier monitoring.

Aspect 8: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-7.

Aspect 9: An apparatus for network communication at a device, the apparatus comprising one or more memories and one or more processors coupled to the one or more memories, the one or more processors configured to cause the device to perform the method of one or more of Aspects 1-7.

Aspect 10: An apparatus for network communication, the apparatus comprising at least one means for performing the method of one or more of Aspects 1-7.

Aspect 11: A non-transitory computer-readable medium storing code for network communication, the code comprising instructions executable by one or more processors to perform the method of one or more of Aspects 1-7.

Aspect 12: A non-transitory computer-readable medium storing a set of instructions for network communication, the set of instructions comprising one or more instructions that, when executed by one or more processors of a device, cause the device to perform the method of one or more of Aspects 1-7.

Aspect 13: A device for network communication, the device comprising a processing system that includes one or more processors and one or more memories coupled with the one or more processors, the processing system configured to cause the device to perform the method of one or more of Aspects 1-7.

Aspect 14: An apparatus for network communication at a device, the apparatus comprising one or more memories and one or more processors coupled to the one or more memories, the one or more processors individually or collectively configured to cause the device to perform the method of one or more of Aspects 1-7.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for network communication at a network entity, comprising:
one or more memories; and
one or more processors, coupled to the one or more memories, configured to cause the network entity to:
transmit a command-based operation configuration for a plurality of readers;
transmit an indication of an allocation of one or more time query resources or frequency query resources to one or more first readers of the plurality of readers;
transmit an indication of an allocation of one or more time random number (RN) carrier wave (CW) resources or frequency RN CW resources to one or more second readers of the plurality of readers;
transmit an indication of an allocation of one or more time acknowledgment (ACK) resources or frequency ACK resources to one or more third readers of the plurality of readers; and
transmit an indication of an allocation of one or more time identifier CW resources or frequency identifier CW resources to one or more fourth readers of the plurality of readers.

2. The apparatus of claim 1, wherein the command-based operation configuration is associated with ambient internet of things (IoT) inventory.

3. The apparatus of claim 1, wherein the one or more time query resources or frequency query resources include the one or more time query resources.

4. The apparatus of claim 1, wherein the one or more time query resources or frequency query resources include one or more channels allocated to respective readers of the one or more first readers.

5. The apparatus of claim 1, wherein the one or more processors are further configured to cause the network entity to:
transmit an indication of query content information associated with the one or more time query resources or frequency query resources.

6. The apparatus of claim 1, wherein the one or more processors are further configured to cause the network entity to:
transmit an indication of an assignment of the one or more second readers to CW transmission and one or more fifth readers of the plurality of readers to RN monitoring.

7. The apparatus of claim 1, wherein the one or more processors are further configured to cause the network entity to:
transmit an indication of an assignment of the one or more second readers to CW transmission and one or more fifth readers of the plurality of readers to identifier monitoring.

8. A method of network communication performed by a network entity, comprising:
transmitting a command-based operation configuration for a plurality of readers;
transmitting an indication of an allocation of one or more time query resources or frequency query resources to one or more first readers of the plurality of readers;
transmitting an indication of an allocation of one or more time random number (RN) carrier wave (CW) resources or frequency RN CW resources to one or more second readers of the plurality of readers;
transmitting an indication of an allocation of one or more time acknowledgment (ACK) resources or frequency ACK resources to one or more third readers of the plurality of readers; and
transmitting an indication of an allocation of one or more time identifier CW resources or frequency identifier CW resources to one or more fourth readers of the plurality of readers.

9. The method of claim 8, wherein the command-based operation configuration is associated with ambient internet of things (IoT) inventory.

10. The method of claim 8, wherein the one or more time query resources or frequency query resources include the one or more time query resources.

11. The method of claim 8, wherein the one or more time query resources or frequency query resources include one or more channels allocated to respective readers of the one or more first readers.

12. The method of claim 8, further comprising:
transmitting an indication of query content information associated with the one or more time query resources or frequency query resources.

13. The method of claim 8, further comprising:
transmitting an indication of an assignment of the one or more second readers to CW transmission and one or more fifth readers of the plurality of readers to RN monitoring.

14. The method of claim 8, further comprising:
transmitting an indication of an assignment of the one or more second readers to CW transmission and one or more fifth readers of the plurality of readers to identifier monitoring.

15. An apparatus for network communication, comprising:
means for transmitting a command-based operation configuration for a plurality of readers;
means for transmitting an indication of an allocation of one or more time query resources or frequency query resources to one or more first readers of the plurality of readers;
means for transmitting an indication of an allocation of one or more time random number (RN) carrier wave (CW) resources or frequency RN CW resources to one or more second readers of the plurality of readers;
means for transmitting an indication of an allocation of one or more time acknowledgment (ACK) resources or frequency ACK resources to one or more third readers of the plurality of readers; and
means for transmitting an indication of an allocation of one or more time identifier CW resources or frequency identifier CW resources to one or more fourth readers of the plurality of readers.

16. The apparatus of claim 15, wherein the command-based operation configuration is associated with ambient internet of things (IoT) inventory.

17. The apparatus of claim 15, wherein the one or more time query resources or frequency query resources include the one or more time query resources.

18. The apparatus of claim 15, wherein the one or more time query resources or frequency query resources include one or more channels allocated to respective readers of the one or more first readers.

19. The apparatus of claim 15, further comprising:
means for transmitting an indication of query content information associated with the one or more time query resources or frequency query resources.

20. The apparatus of claim 15, further comprising:
means for transmitting an indication of an assignment of the one or more second readers to CW transmission and one or more fifth readers of the plurality of readers to RN monitoring.
